(19) United States
(12) Patent Application Publication
(10) Pub. No.: US 2024/0066620 A1
(43) Pub. Date: Feb. 29, 2024

(54) FEEDER MOUNT FOR ROBOTIC WELDING SYSTEM

(71) Applicant: ESAB AB, Gothenburg (SE)

(72) Inventors: Carl Johan Langeström, Gothenburg (SE); Niclas Frederiksen, Gothenburg (SE); Johan Johansson, Vedum (SE)

(21) Appl. No.: 17/894,810

(22) Filed: Aug. 24, 2022

(51) Int. Cl. B23K 9/12; B23K 11/31; B23K 37/02

(52) U.S. Cl. CPC B23K 9/125; B23K 11/314; B23K 37/02

(57) ABSTRACT

A quick release mounting assembly or connector assembly for connecting a wire feeder to a robotic welding system is disclosed. The connector assembly includes an adapter plate configured to mount to a robotic welder of the robotic welding system, a feeder plate configured to couple to a wire feeder of the robotic welding system, and a clamping plate mounted to the adapter plate and configured to clamp the feeder plate to the adapter plate. The feeder plate can be positioned and clamped in place by the clamping plate when the clamping plate is at least partially disposed within a clamping zone.

### FIELD OF INVENTION

The present invention relates to the field of equipment mounts for robotic welding systems and, in particular, a mounting or connector assembly for quickly mounting/releasing a wire feeder to a robotic welding system.

### BACKGROUND

Generally, robotic welding systems include a robot having one or more robot arms, a torch, and a wire feeder for feeding weld wire to the torch. The torch is disposed at a distal end of the robot arm and the wire feeder is disposed between a base of the robot and the torch. A cable connects the wire feeder to the torch and provides one or more of electricity, weld wire, one or more gases, and cooling fluid from the wire feeder.

Typically, mounting the wire feeder to the robot requires one or more tools to properly secure and/or remove the wire feeder to/from a mounting plate of the robot. Accordingly, mounting/removing the wire feeder to/from the robot may be arduous and time consuming.

Moreover, the wire feeder may only be mountable at discrete positions along the mounting plate. That is, the wire feeder may only be able to mount to predetermined positions along the mounting plate of the robot. If the wire feeder is mounted onto the mounting plate of the robot at a position that prevents proper connection to the torch cable (e.g., too far or too close to the robot arm), the wire feeder must be disconnected from the mounting plate and remounted to another discrete position along the mounting plate. Consequently, considerable amount of time and energy may be expended to properly align and mount the wire feeder to the mounting plate of the robot.

### SUMMARY

The techniques presented herein relate to a connector assembly for a robotic welding system, including: an adapter plate configured to mount to a robotic welder of the robotic welding system; a feeder plate, the feeder plate configured to couple to a wire feeder of the robotic welding system; and a clamping plate mounted to the adapter plate and configured to clamp the feeder plate to the adapter plate when at least a portion of the feeder plate is disposed between the clamping plate and the adapter plate.

In some aspects, the techniques described herein relate to an assembly, wherein the feeder plate defines a clamping zone wherein the feeder plate can be positioned and clamped in place with the clamping plate in any location within the clamping zone.

In some aspects, the techniques described herein relate to an assembly, wherein the feeder plate includes a plurality of mounting flanges for mounting the feeder plate to the wire feeder.

In some aspects, the techniques described herein relate to an assembly, wherein the clamping zone includes an area bounded by the plurality of mounting flanges, a front end of the feeder plate, and a back end of the feeder plate.

In some aspects, the techniques described herein relate to an assembly, wherein the feeder plate includes a slot longitudinally from a front end and through the clamping zone.

In some aspects, the techniques described herein relate to an assembly, further including a clamping bolt extending through the adapter plate, the slot, and the clamping plate, wherein the clamping bolt is configured to pull the clamping plate towards the adapter plate.

In some aspects, the techniques described herein relate to an assembly, further including a locking mechanism configured to prevent the feeder plate from sliding off the adapter plate.

In some aspects, the techniques described herein relate to an assembly, wherein the locking mechanism includes a lock housing mounted to the adapter plate and a catch plate disposed in the lock housing, the catch plate being biased towards the feeder plate.

In some aspects, the techniques described herein relate to an assembly, wherein the locking mechanism further includes a protrusion extending from a mounting flange of the feeder plate, and the catch plate further includes a slot configured to receive the protrusion.

In some aspects, the techniques described herein relate to a connector assembly for a welding system, including: a first plate configured to be mounted to a first device of the welding system; a clamping plate operatively coupled to the first plate for applying a clamping force toward the first plate; and a second plate configured to be mounted to a second device of the welding system, the second plate being configured to slide between the first plate and the clamping plate, wherein the second plate is secured to the first plate when at least a portion of the second plate is disposed between the first plate and the clamping plate and the clamping plate applies the clamping force on the second plate.

In some aspects, the techniques described herein relate to a connector assembly, wherein the second plate defines a clamping zone configured to receive the clamping force, wherein the clamping zone is larger than the clamping plate.

In some aspects, the techniques described herein relate to a connector assembly, further including a locking mechanism configured to prevent the second plate from sliding off the first plate.

In some aspects, the techniques described herein relate to a connector assembly, wherein the locking mechanism includes a lock housing mounted to the first plate and a catch plate disposed in the lock housing, the catch plate being biased towards the second plate.

In some aspects, the techniques described herein relate to a connector assembly, wherein: the second plate further includes a mounting flange extending perpendicularly from the second plate, and a protrusion extending perpendicularly from the mounting flange; and the catch plate further includes a slot configured to receive the protrusion.

In some aspects, the techniques described herein relate to a connector assembly, wherein the first device is a robotic welder, and the second device is a wire feeder.

In some aspects, the techniques described herein relate to a method for mounting a wire feeder to a robotic welding system, the method including: sliding a feeder plate mounted to the wire feeder between a clamping plate and an adapter plate mounted to the robotic welding system; positioning the feeder plate such that the clamping plate is at least partially disposed within a clamping area of the feeder plate; and clamping the feeder plate in a desired position with the clamping plate.

In some aspects, the techniques described herein relate to a method, wherein clamping the feeder plate with the clamping plate includes tightening clamping bolts extending from the adapter plate to the clamping plate.

In some aspects, the techniques described herein relate to a method, wherein positioning the feeder plate includes sliding the feeder plate to any position where the clamping plate is at least partially disposed within the clamping area.

In some aspects, the techniques described herein relate to a method, further including preventing the feeder plate from sliding off of the adapter plate via a locking mechanism mounted to the adapter plate, the locking mechanism including a catch plate.

In some aspects, the techniques described herein relate to a method, wherein the feeder plate includes a protrusion extending from the feeder plate, and wherein preventing the feeder plate from sliding off of the adapter plate includes engaging the protrusion with a slot disposed in the catch plate.

### BRIEF DESCRIPTION OF THE DRAWINGS

To complete the description and in order to provide for a better understanding of the present invention, a set of drawings is provided. The drawings form an integral part of the description and illustrate an embodiment of the present invention, which should not be interpreted as restricting the scope of the invention, but just as an example of how the invention can be carried out. The drawings comprise the following figures:

FIG. 1 is a side view of a robotic welding system with a connector assembly according to an embodiment.

FIG. 2A is an isolated perspective view of the connector assembly of the robotic welding system of FIG. 1.

FIG. 2B is an exploded view of the connector assembly of FIG. 2A.

FIGS. 3A and 3B illustrate front and rear perspective views of the connector assembly of FIG. 2A with a feeder mount disposed in the forwardmost position.

FIGS. 3C and 3D illustrate front and rear perspective views of the connector assembly of FIG. 2A with the feeder mount disposed in the rearmost position.

FIGS. 3E and 3F illustrate front and rear perspective views of the connector assembly of FIG. 2A with the feeder mount disposed in between the rearmost and forwardmost positions.

FIG. 4A is a perspective rear view of a wire feeder mounted to the connector assembly of FIG. 2A.

FIG. 4B depicts a cross-sectional view of the connector assembly taken along line B-B of FIG. 4A.

FIGS. 5A and 5B are side views of the robotic welding system of FIG. 1 that depict installation of the wire feeder to the robotic welder via the connector assembly.

FIG. 6 is a flow chart illustrating a method for mounting a wire feeder to a robotic welder with the connector assembly illustrated in FIG. 2A.

FIGS. 7A and 7B show exploded views of a locking mechanism next to the connector assembly of FIG. 2A.

FIGS. 7C and 7D are side views of the locking mechanism in FIG. 7A.

FIG. 7E is a cross-sectional view of the locking mechanism taken along lines E-E of FIGS. 7C and 7D.

FIG. 7F is a partial top view of the connector assembly of FIG. 2A with the locking mechanism engaging a protrusion.

FIG. 7G is a partial perspective view of the connector assembly of FIG. 2A with a partial cross-section of the locking mechanism taken along lines E-E of FIGS. 7C and 7D.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

Generally, the system and method for mounting a wire feeder to a robotic welding system, as presented herein, include a connector assembly including an adapter plate configured to mount to a robotic welder of the robotic welding system, a feeder plate configured to mount to a wire feeder, and a clamping plate configured to clamp the feeder plate to the adapter plate. The feeder plate is configured to slide between the clamping plate and adapter plate. The clamping plate may apply a clamping pressure via clamping bolts. The clamping bolts may be tightened by hand. Consequently, the feeder plate may be clamped to the adapter plate by hand and without tools. Accordingly, the wire feeder coupled to the feeder plate can be quickly, easily, and reliably mounted to the robotic welding system by hand without tools.

Additionally, the wire feeder can be disposed in any desired position along the adapter plate to properly align the wire feeder and robotic welder. The feeder plate includes a clamping area or zone in which the clamping plate may engage the feeder plate in order to clamp the feeder plate to the adapter plate. That is, the feeder plate may be disposed and clamped in any longitudinal position within the clamping area. Therefore, the wire feeder can be set at any desired position along the adapter plate. Consequently, a user can quickly and easily dispose and align the wire feeder at a desired position the with respect to the robotic welder, and tighten the clamping plate by hand to reliably mount the wire feeder to the robotic welder.

Moreover, a locking mechanism locks the feeder plate between the adapter plate and the clamping plate (while still enabling the feeder plate to slide between the adapter plate and the clamping plate) to prevent the wire feeder from disengaging from the robotic welder. The locking mechanism serves as a stop to prevent the feeder plate from translating such that the clamping area is not aligned with the clamping plate. The locking mechanism may automatically engage in response to the feeder plate translating towards a back end of the connector. That is, once the feeder plate is positioned between the clamping plate and the adapter plate, the locking mechanism is automatically positioned to prevent the wire feeder from sliding or translating off the robotic welder. Therefore, the locking mechanism prevents inadvertent release of the wire feeder.

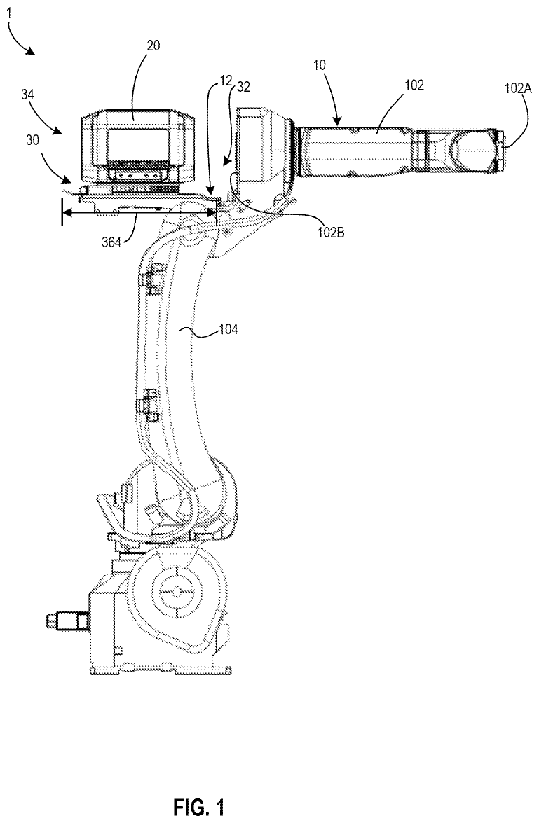

Now referring to FIG. 1, a side view of a robotic welding system 1 according to an embodiment is illustrated. The robotic welding system 1 includes a robotic welder 10, a wire feeder 20, and a quick release mounting assembly or connector assembly 30. As explained in further detail below, the feeder 20 is disposed on the connector assembly 30, which is disposed on a robot mount 12 located between a robot arm 102 and a robot base 104. The robot arm 102 may extend from a proximal end 102B to a distal end 102A. A welding torch (not shown) may be disposed at the distal end 102A of the robot arm 102. The wire feeder 20 may conduct a weld wire from a wire supply (e.g., internal or external to the wire feeder 20) through, or along, the robot arm 102 to the torch via a cable (not shown). The wire feeder 20 may be coupled to a power source and/or a gas source (not shown) to conduct power and/or a process gas through the cable and the robot arm 102 to the torch.

The connector assembly 30 couples the wire feeder 20 to the robot mount 12, and allows the feeder 20 to be set along a longitudinal axis 364 between a front end 32 and back end 34 of the connector assembly 30. That is, the connector assembly 30 allows the user to adjust the position of the feeder 20 to any position along the longitudinal axis 364 with respect to the proximal end 102B of robot arm 102 and/or robot mount 12, and then lock the feeder 20 in place without any tools. That is, the connector assembly 30 may be adjusted to set a desired distance between the wire feeder 20 and the proximal end 102B of the robot arm 102.

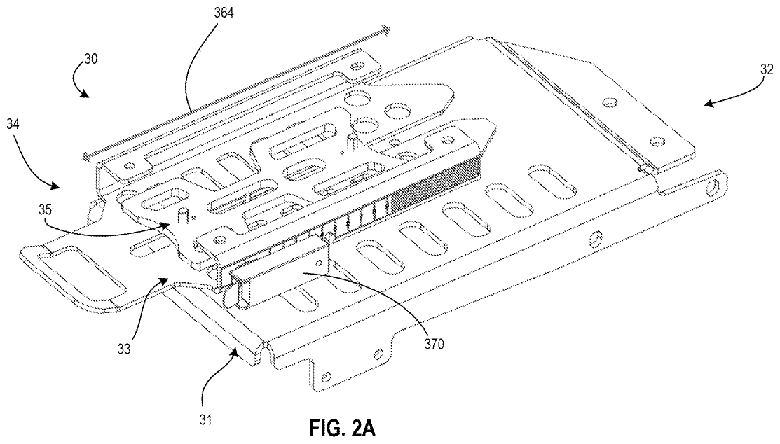

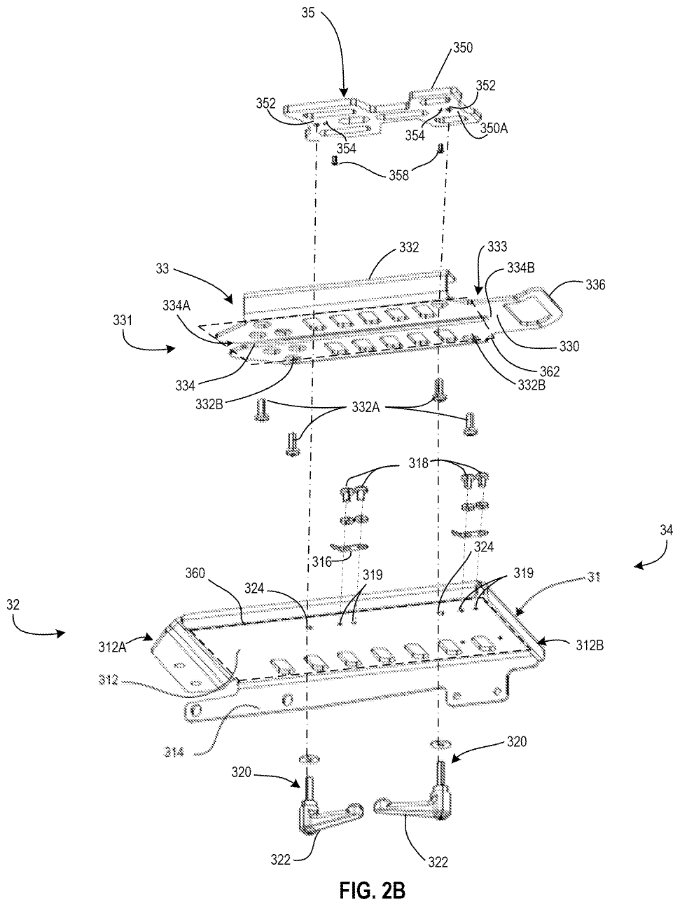

Now referring to FIGS. 2A and 2B, an isolated perspective view and an exploded view of the connector assembly 30 are illustrated. The connector assembly 30 includes a robot mount adapter 31, a feeder mount 33, a clamp 35, and a locking mechanism 370 (not shown in the exploded view of FIG. 2B). The robot mount adapter 31 may be configured to be mounted to the robot mount 12. The feeder mount 33 may be configured to be mounted to the wire feeder 20 and receive the clamp 35 between a bottom of the wire feeder 20 and the feeder mount 33. As explained in further detail below, the clamp 35 may be configured to clamp the feeder mount 33 to the robot mount adapter 31. Consequently, the connector assembly 30 may affix the wire feeder 20 to the robot 10 via frictional forces applied to the feeder mount 33 by the robot mount adapter 31 and clamp 35. As explained further below, the locking mechanism 370 may be mounted to the robot mount adapter 31 and may engage a protrusion 338 extending from the flange 332 to prevent the feeder mount 33 from sliding off the robot mount adapter 31 towards the back end 34 of the connector assembly 30.

The robot mount adapter 31 may include a base plate or adapter plate 312 having a front end 312A and a back end 312B, a robot mounting flange 314, lift spring 316, spring screws 318, and clamping bolts 320. The adapter plate 312 may be substantially flat (e.g., planar) and rectangular and may define a mounting area 360 for receiving the wire feeder 20 and feeder mount 33. That is, the wire feeder 20 and feeder mount 33 are supported by the adapter plate 312 when disposed within the mounting area 360 (the area bounded by the broken lines in the depicted embodiment) of the robot mount adapter 31. The position of the feeder 20 can be adjusted via the connector assembly 30 to accommodate cables or other connections between the feeder 20 and the robotic welder 10.

Still referring to FIGS. 2A and 2B, the robot mounting flange 314 extends substantially perpendicular from the adapter plate 312 and is configured to mount or otherwise fix the robot mount adapter 31 to the robot mount 12. For example, the robot mount adapter 31 may be specifically configured for certain type(s) of robot mount(s). That is, robot mounting flange 314 may be configured to mount to one or more specific types of robot mounts 12 of a robotic welder 10. Thus, the robot mounting flange 314 and the adapter plate 312, along with other components of the robot mount adapter 31 may be of any size and dimension than that depicted in FIGS. 2A and 2B. Accordingly, a user may select a connector assembly 30 with a robot mount adapter 31 that corresponds to a desired robot mount 12. Additionally or alternatively, the connector assembly 30 may be packaged with a plurality of robot mount adapters corresponding to one or more different types of robot mounts. In some implementations, the robot mount adapter 31 includes a mounting structure specifically configured for a desired robot mount 12.

Regardless of how the robot mount adapter 31 mounts to the robot mount 12, the adapter plate 312 is configured to cooperate with the clamp 35 to clamp the feeder mount 33 in a desired position. The adapter plate 312 may further include a plurality of through-holes 324 configured to receive the clamping bolts 320 and a plurality of threaded holes 319 for receiving the spring screws 318. The clamping bolts 320 may extend through the through-holes 324 and engage the clamp 35. The clamping bolts 320 may be tightened in order to pull the clamp 35 towards the adapter plate 312. For example, the clamping bolts 320 may be threaded and configured to engage a threaded opening in the clamp 35. The clamping bolts 320 may include handles 322 that a user can grasp to tighten the clamping bolts 320. When the feeder mount 33 is disposed between the clamp 35 and the adapter plate 312, the user can rotate the handles 322 to cause the bolts 320 to pull the clamp 35 towards the feeder mount 33 and the adapter plate 312 to apply a clamping pressure to at least a portion of the feeder mount 33. Consequently, the feeder mount 33 may be easily positioned between the clamp 35 and the adapter plate 312 and then coupled to the robot mount adapter 31 by tightening the clamping bolts 320 by hand.

To assist in the insertion of the feeder mount 33, the adapter plate 312 may be equipped with lift springs 316 that are configured to separate the clamp 35 from the adapter plate 312 and to provide a clearance for the feeder mount 33 between the adapter plate 312 and the clamp 35. The spring screws 318 may fasten the lift springs 316 to the adapter plate 312. In the depicted embodiment, the lift springs 316 are leaf springs. That is, the lift springs 316 comprise a strip of resilient material (e.g., stainless steel) that is bent away from the adapter plate 312 and towards the clamp 35. In other embodiments, the lift springs 316 may be any other type and shape of resilient material. Two spring screws 318 may extend through two through-holes of each lift spring 316 and engage threads formed in the first plurality of threaded holes 319 in the adapter plate 312. Washers may be disposed between heads of the spring screws 318 and the lift springs 316. Each lift spring 316 may apply a lifting force to the clamp 35 thereby lifting the clamp 35 above the top surface of the adapter plate 312 by a standoff distance. The standoff distance provides the clearance for at least a portion of the feeder mount 33 to slide between the clamp 35 and the adapter plate 312.

When the feeder mount 33 is disposed in the desired position along the adapter plate 312, the clamp 35 is tightened via the clamping bolts 320 and the lift springs 316 resiliently deflect and/or compress towards the adapter plate 312. The clamp 35 may include a stop for each lift spring 316 to prevent plastic deformation of the lift springs 316 when the feeder mount 33 is removed. In the depicted embodiment, the stop, discussed further below, comprises a lift screw 358 threaded into the clamp 35. Alternatively, the lift spring 316 may be omitted and the lift screw 358 may vertically offset the clamp 35 from the adapter plate 312.

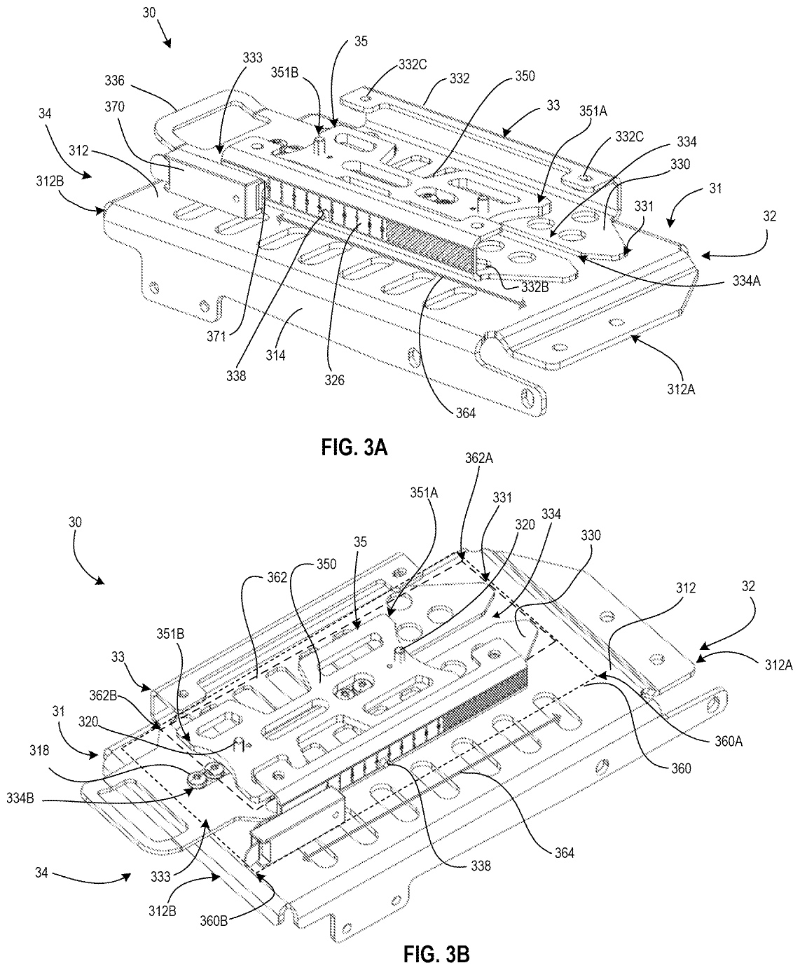

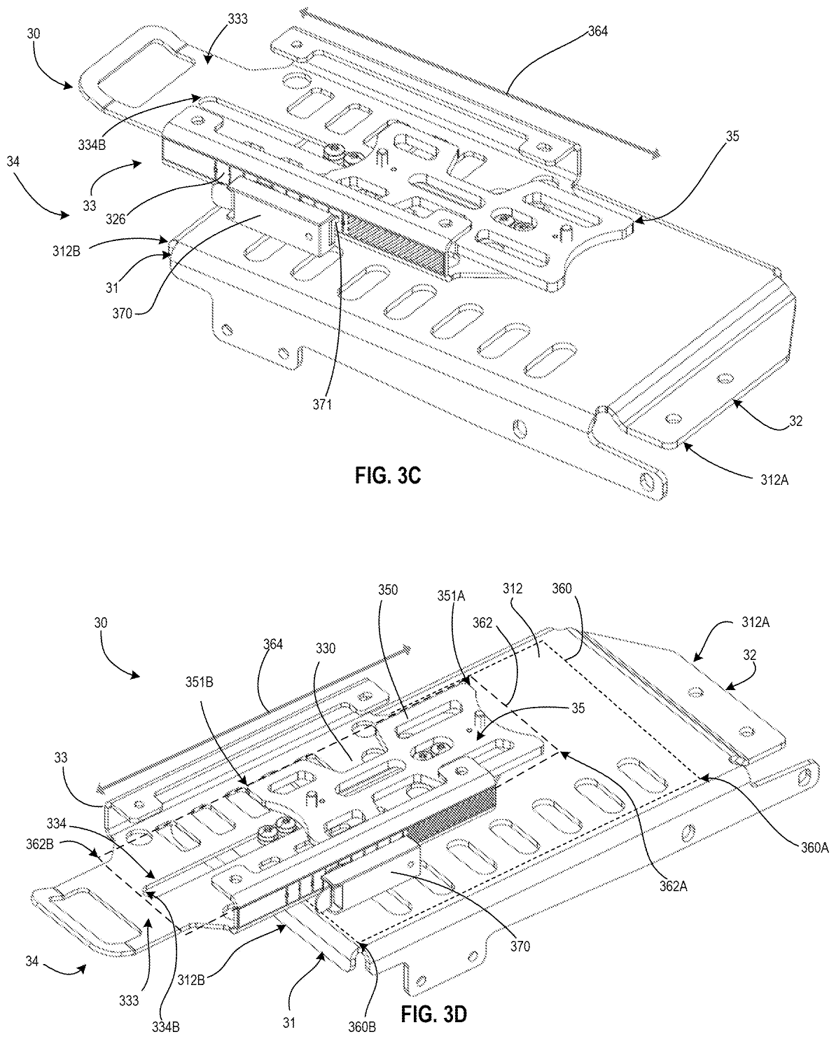

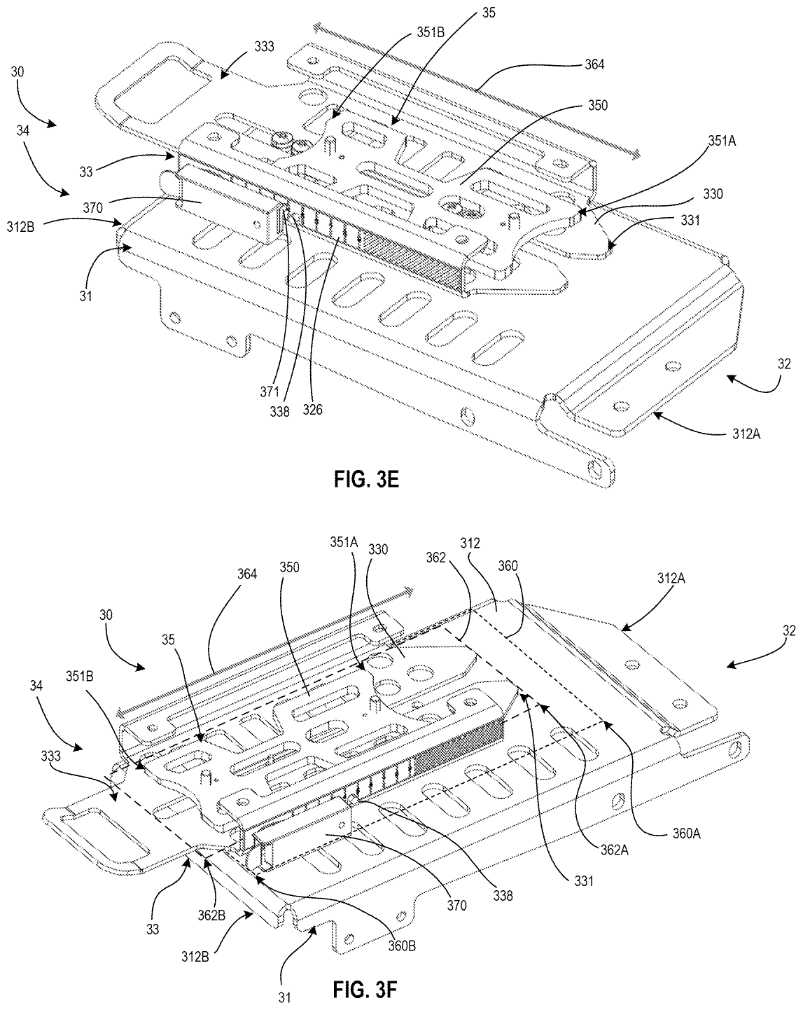

Still referring to FIGS. 2A and 2B, the feeder mount 33 may comprise a feeder plate 330 having a front end 331 and a back end 333, mounting flanges 332 extending between the front end 331 and back end 333, a feeder slot 334 extending along the middle of the feeder plate 330 from the front end 331 towards the back end 333, and a handle 336 disposed at the back end 333. The handle 336 may provide a grip area for a user to engage with adjust the position of the feeder mount 33 (and an attached wire feeder 20) along the longitudinal axis 364 (see FIGS. 3A-3D).

The mounting flanges 332 may be disposed on opposing sides of the feeder plate 330 from one another, and may be configured to receive and support the wire feeder 20. The mounting flanges 332 have a generally “C” shaped cross-section. Mounting bolts 332A may extend through the mounting holes 332C of the mounting flanges 332 to couple the mounting flanges 332 to the bottom of the feeder 20 (and, ultimately, the wire feeder 20 to the feeder mount 33). In the depicted embodiment, access holes 332B allow the mounting bolts 332A to be inserted into the mounting holes 332C (see FIGS. 2A, 2B, and 3A) in the mounting flanges 332 to couple the feeder mount 33 to the wire feeder 20. In some implementations, the flanges may have a generally “L” shape and engage the sides of the feeder 20. Additionally, or alternatively, the flanges may have any shape capable of supporting a desired wire feeder 20. In even further embodiments, the feeder mount 33 may be equipped with posts or cylinders that operate in a similar manner to the mounting flanges 332 to connect the wire feeder 20 to the feeder mount 33. As further detailed below, and as best shown in FIGS. 3A-3F, the side of one of the mounting flanges 332 may include a scale 326.

As further illustrated in FIGS. 2A and 2B, the feeder plate 330 may define a clamping area or zone 362 for receiving a clamping force/pressure from the clamp 35 and the adapter plate 312. That is, the clamping area 362 may be a portion of the feeder plate 330 that is configured to be clamped between the clamp 35 and the adapter plate 312. To be clear, in the depicted embodiment, the clamping area 362 is the portion of the feeder plate 330 defined by illustrated broken lines bounded by the front end 331, the handle 336, and the mounting flanges 332.

The feeder slot 334 may be configured to guide the feeder mount 33 onto the robot mount adapter 31 and accommodate the clamping bolts 320 extending from the adapter plate 312 to the clamp 35. The feeder slot 334 includes a slot front end 334A and a slot back end 334B. The slot front end 334A may include angled surfaces that define an opening or slot entrance that tapers to a final width of the slot 334. Thus, the slot entrance of the feeder slot 334 at the slot front end 334A may have a width that is wider than the remaining portions of the feeder slot 334. The tapered shape of the slot entrance cooperates with the clamping bolts 320 to guide the feeder mount 33 into position with the robot mount adapter 31. That is, when a user slides the feeder mount 33 onto the robot mount adapter 31, the slot front end 334A defining the slot entrance cooperates with the clamping bolts 320 to laterally adjust the portion of the feeder plate 330. The angled surfaces of the slot front end 334A may engage the clamping bolts 320 to guide the clamping bolts 320 into the feeder slot 334 and simultaneously adjust a lateral position of the feeder plate 330 with respect to the adapter plate 312 as the feeder mount 33 is inserted on to the robot mount adapter 31. Consequently, the clamping area 362 is laterally aligned with the clamp 35 and mounting area 360 when the slot 376 fully receives the clamping bolt 320. Accordingly, a user can easily align the feeder mount 33 with the clamp 35 and the robot mount adapter 31.

The slot back end 334B may be configured cooperate with the spring screws 318 to stop the feeder mount 33 from translating beyond the mounting area 360 and/or sliding off the front end 312A of the adapter plate 312. That is, the slot back end 334B may engage or contact one of the spring screws 318 when the feeder mount 33 is translated to its forwardmost position towards the front end 312A of the adapter plate 312. Consequently, the contact between the slot back end 334B and the spring screw 318 may prevent the feeder mount 33 from translating past the mounting area 360 and/or beyond the front end 312A of the adapter plate 312. Accordingly, the arrangement of the connector assembly 30 prevents translating an entirety of the feeder mount 33 beyond the mounting area 360 and/or sliding off the front end 32 of the adapter plate 312 while the user easily positions and aligns the clamping area 362 of the feeder plate 330 with the clamp 35. In some implementations, the clamping bolts 320 may engage or contact the slot back end 334B to prevent the feeder mount 33 for extending beyond the mounting area 360 towards the front end 32.

With continued reference to FIGS. 2A and 2B, and as previously explained above, the clamp 35 may be configured to clamp the feeder mount 33 to the robot mount adapter 31. The clamp 35 may include a clamping plate 350 having a generally dog bone shape, a clamping surface 350A facing the adapter plate 312 and/or the feeder plate 330, a front end 351A and an opposite back end 351B, and a plurality of threaded openings 352 and 354 disposed in the clamping plate 350. As previously explained, the clamping bolts 320 may extend through the adapter plate 312 and the feeder slot 334 in the feeder plate 330 to engage the threaded openings 352 of the clamping plate 350. The clamp 35 may be movably coupled to the adapter plate 312 through the tightening or loosening of the clamping bolts 320. Tightening the clamping bolts 320 may pull the clamping plate 350 towards the adapter plate 312. Conversely, loosening the clamping bolts 320 may push or translate the clamping plate 350 away from the adapter plate 312. The clamping surface 350A of the clamping plate 350 may be configured to engage/contact the feeder plate 330 in order to apply a clamping force/pressure to the feeder plate 330. Thus, tightening or loosening the clamping bolts 320 adjusts the amount of clamping force applied to the feeder plate 330 when the feeder mount 33 is disposed between the clamp 35 and the robot mount adapter 31.

As noted above, the clamp 35 further includes a stop to prevent plastic deformation of the lift springs 316 due to over tightening of the clamping plate 350 when the feeder mount 33 is absent. In the depicted embodiment, the stop comprises lift screws 358 threaded into threaded openings 354 of the clamping plate 350. For example, when the feeder mount 33 is removed from the robot mount adapter 31 and/or the clamping bolts 320 are loosened, the lift springs 316 apply a lifting force to the clamping surface 350A thereby creating a clearance gap between the clamping plate 350 and the adapter plate 312. The clearance gap allows the user to insert the feeder plate 330 between the clamping plate 350 and the adapter plate 312. The lift screws 358 prevent the lift springs 316 from plastically deforming due to overtightening of the clamp 35 when the feeder mount 33 is not present. For example, each lift screw 358 bears against a distal end of each lift spring 316 to prevent further deformation of the lift spring 316. In some implementations, the heads of the lift screws 358 bear against the adapter plate 312 and prevent the clamping plate 350 from being overtightened and from plastically deforming the lift springs 316. Alternatively, the lift spring 316 may be omitted and the lift screw 358 may support the clamping plate 350 on the adapter plate 312, thereby providing the clearance gap between the robot mount adapter 31 and the clamp 35.

When the feeder mount 33 is disposed between the clamp 35 and the robot mount adapter 31, the clamping force applied by the clamping plate 350 to the feeder plate 330 secures the feeder mount 33 in place. The clamping force increases both the friction between the clamping plate 350 and the feeder plate 330 and the friction between the feeder plate 330 and the adapter plate 312 when the feeder plate 330 is disposed between the clamp 35 and the robot mount adapter 31. The user can tighten the clamping bolts 320 to increase the clamping force to generate sufficient friction between the clamping plate 350 and the feeder plate 330 and between the feeder plate 330 and the adapter plate 312 to hold the feeder mount 33 in place. That is, the friction between the feeder plate 330 and the adapter plate 312, and the friction between the feeder plate 330 and the clamping plate 350 prevents longitudinal movement of the feeder mount 33.

Additionally, the user may loosen the clamping bolts 320 to adjust the position of the feeder mount 33 such that the clamping plate 350 is aligned within the clamping area 362 of the feeder plate 330, and the feeder plate 330 is aligned with at least a portion of the mounting area 360 of the adapter plate 312. For example, the user may loosen the clamping bolts 320 to reduce the clamping force between the clamping plate 350, feeder plate 330, and adapter plate 312. The user may adjust the position of the feeder mount 33 to accommodate connections (e.g., cables) between the wire feeder 20 and the robotic welder 10. That is, a longitudinal position of the feeder mount 33 may be varied along the longitudinal axis 364 to any desired longitudinal position wherein the clamping plate 350 is within the clamping area 362. With the feeder plate 330 set in the desired position, the user can fix the feeder mount 33 by tightening the clamping bolts 320.

Referring to FIGS. 3A-3F, front and rear perspective views of the connector assembly 30 with the feeder mount 33 disposed in different positions along a longitudinal axis 364 of the robot mount adapter 31 are illustrated. FIGS. 3A and 3B illustrate the front and rear perspective views of the connector assembly 30 with the feeder mount 33 disposed in the forwardmost position (e.g., towards the front end 32 of the connector assembly 30 or the front end 312A of the adapter plate 312). As best shown in FIG. 3B, the forward edge 362A of the clamping area 362 (i.e., proximate to the front end 331 of the feeder plate 330) is aligned with the front end 360A of the mounting area 360 (i.e., proximate to the front end 312A of the adapter plate 312). The rearward edge 362B of the clamping area 362 is aligned with the back end 351B of the clamping plate 350.

A scale 326 disposed on the mounting flange 332 of the feeder mount 33 cooperates with the locking mechanism 370 having a pointer or indicator 371 to indicate the position of the feeder plate 330 with respect to the adapter plate 312. The scale 326 includes a plurality of reference positions labeled 0-9. That is, the scale 326 provides a forward most position (e.g., 0) and a rearward most position (e.g., 9) in which the clamping area 362 of the feeder plate 330 is aligned with the clamping plate 350. The reference positions may be indicative of a distance to the forwardmost position of the feeder mount 33 (and thus, the connected wire feeder 20) with reference to the adapter plate 312 and the robot arm 102.

For example, in FIGS. 3A and 3B, the indicator 371 is aligned with the “0” position. Thus, the feeder plate 330 is at the forwardmost position with respect to the adapter plate 312. That is, the feeder plate 330 is 0 centimeters from the forwardmost position. For example, the front end 331 of the feeder plate 330 is 0 centimeters from the front end 312A of the adapter plate 312. Therefore, the scale 326 provides a reference of allowable positions in which the feeder mount 33, and thus the wire feeder 20, may be positioned along the robot mount adapter 31.

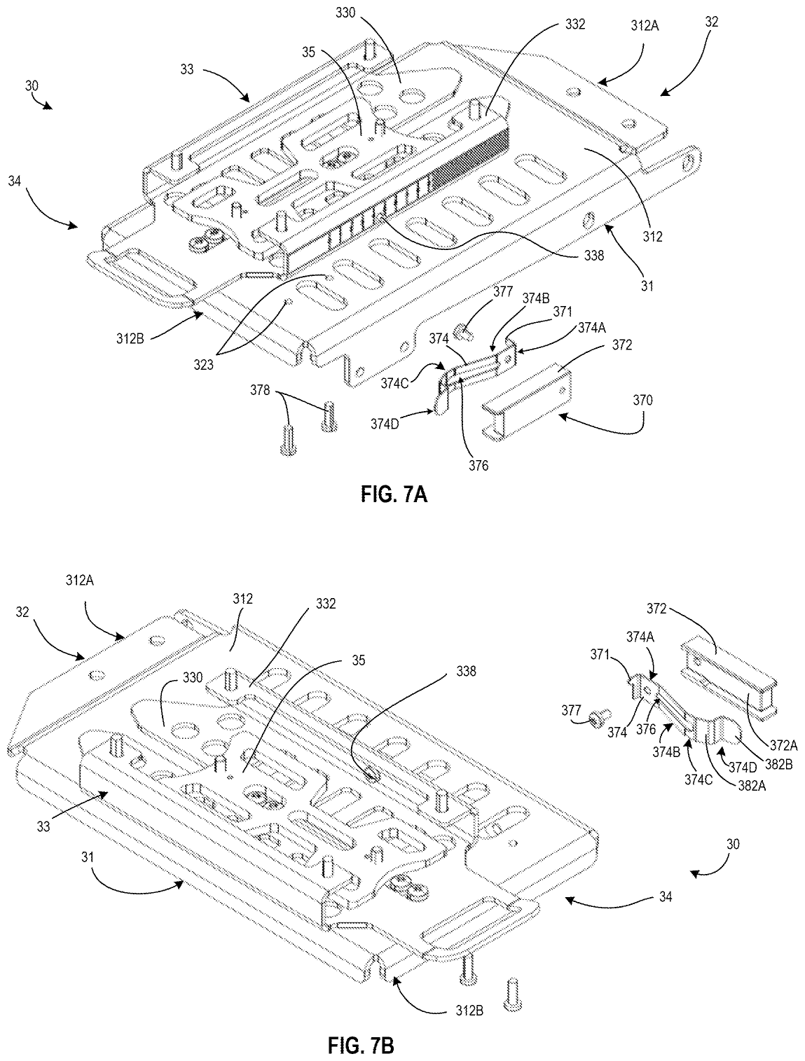

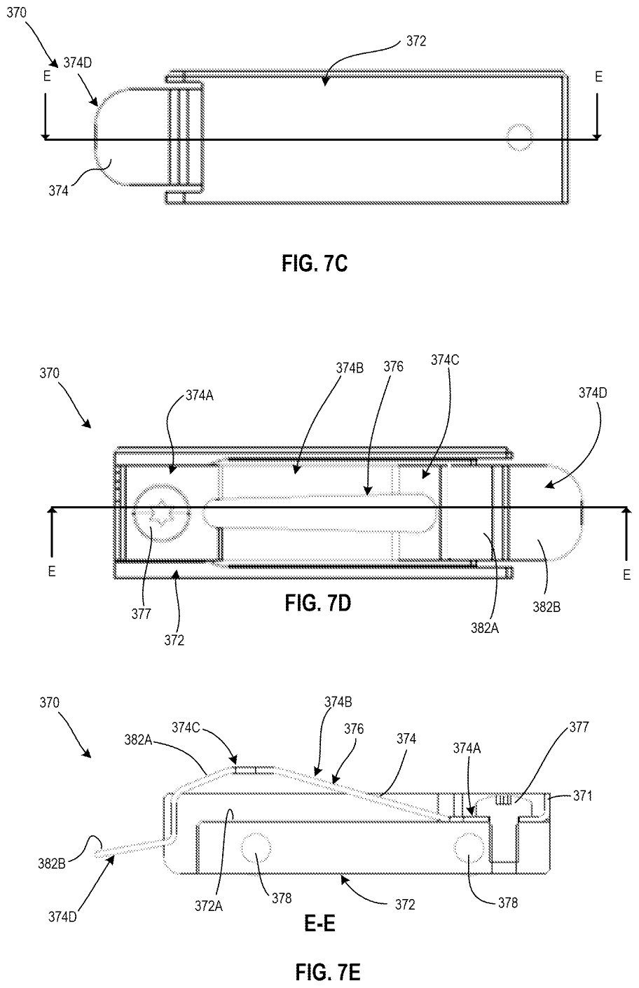

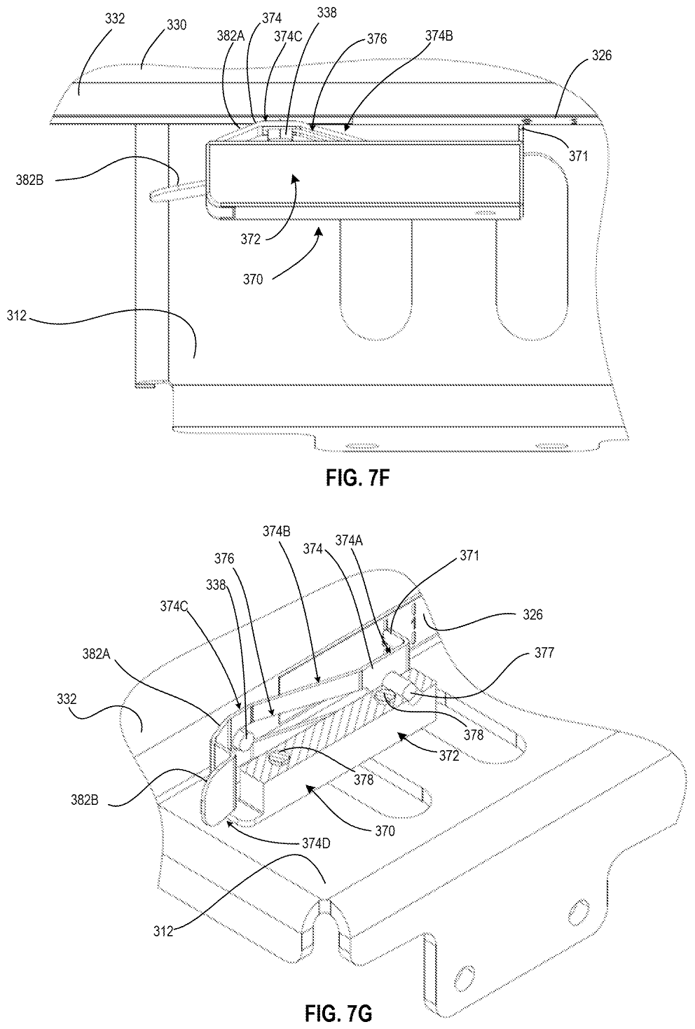

As depicted in FIGS. 3C and 3D, the feeder mount 33 is disposed at its rearmost position along the longitudinal axis 364 with respect to the adapter plate 312 (e.g., towards the back end 312B of the adapter plate 312). That is, the feeder plate 330 is positioned between the clamp 35 and the robot mount adapter 31 such that the front end 351A of clamping plate 350 is aligned with a forward edge 362A of the clamping area 362. This being the rearmost position of the feeder plate 330 along the longitudinal axis 364, the indicator 371 points to the highest number (e.g., 9) indicating the feeder mount 33 is at an end of the scale 326. That is, the feeder plate 330 is 9 centimeters back from the from the forwardmost position with respect to the adapter plate 312. As further illustrated, the rearward edge 362B of the clamping area 362 (i.e., proximate to the back end 333 of the feeder plate 330), extends beyond the back end 360B of the mounting area 360 and beyond the back end 312B of the adapter plate 312). As discussed further below with reference to FIGS. 7F and 7G, the locking mechanism 370 may automatically engage the protrusion 338 extending from the flange 332 and may prevent the feeder mount 33 from translating further towards the back end of the connector assembly 30.

As noted above, while FIGS. 3A and 3B depict the feeder mount 33 in the forwardmost position and FIGS. 3C and 3D depict the feeder mount 33 in the rearmost position, the feeder mount 33 may be disposed in any position along the longitudinal axis 364. For example, FIGS. 3E and 3F depict the feeder mount 33 disposed on the adapter plate 312 between the forwardmost position (see FIGS. 3A and 3B) and rearmost position (see FIGS. 3C and 3D). The indicator 371 is aligned with the “4” position. That is, the feeder plate 330 is four centimeters from the forwardmost position. However, the feeder mount 33 may be disposed along the longitudinal axis 364 such that the indicator 371 is positioned between the minimum and maximum of the scale 326. That is, the feeder mount 33 does not need to be set such that the indicator 371 is aligned with a discrete number along the scale, and may be positioned such that the indicator 371 is between discrete numbers of the scale 326. While the scale is numbered with reference to a distance from the forwardmost position of the feeder plate 330 with respect to the adapter plate 312, embodiments are not limited thereto. In some implementations, the scale 326 may be numbered with reference to a distance from the rearmost position of the feeder plate 330 with respect to the adapter plate 312. In some implementations, the scale may be numbered with clearances between the wire feeder 20 and the robot 10.

As noted above, the feeder mount 33 may be disposed and fixed in any position/location along the longitudinal axis 364 of the robot mount adapter 31 as long as at least a portion of the clamping area 362 of the feeder plate 330 overlaps with the clamping plate 350. That is, the longitudinal position of the feeder mount 33 can be adjusted such that the clamping plate 350 is at least partially disposed within the clamping area 362 of the feeder plate 330. Therefore, the feeder mount 33 may be fixed to the adapter 31 via the clamp 35 in any longitudinal position so long as the clamping plate 350 engages the feeder plate 330 within the clamping area 362.

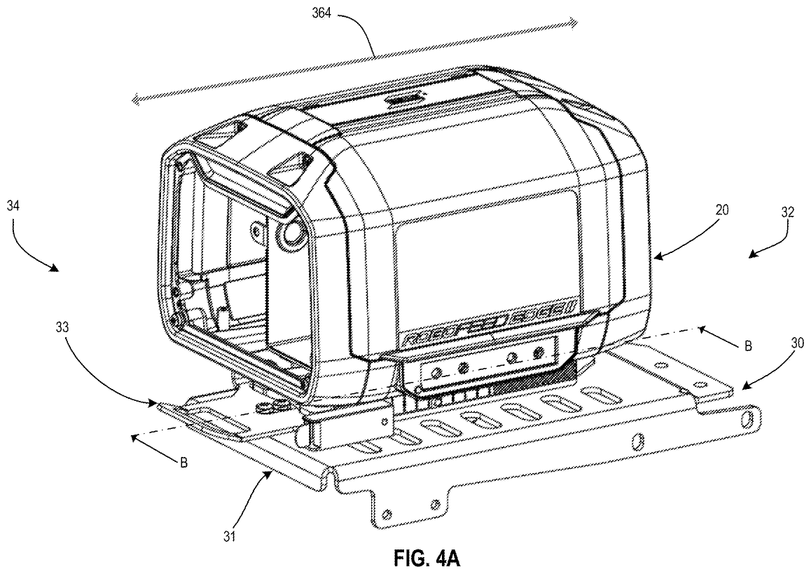

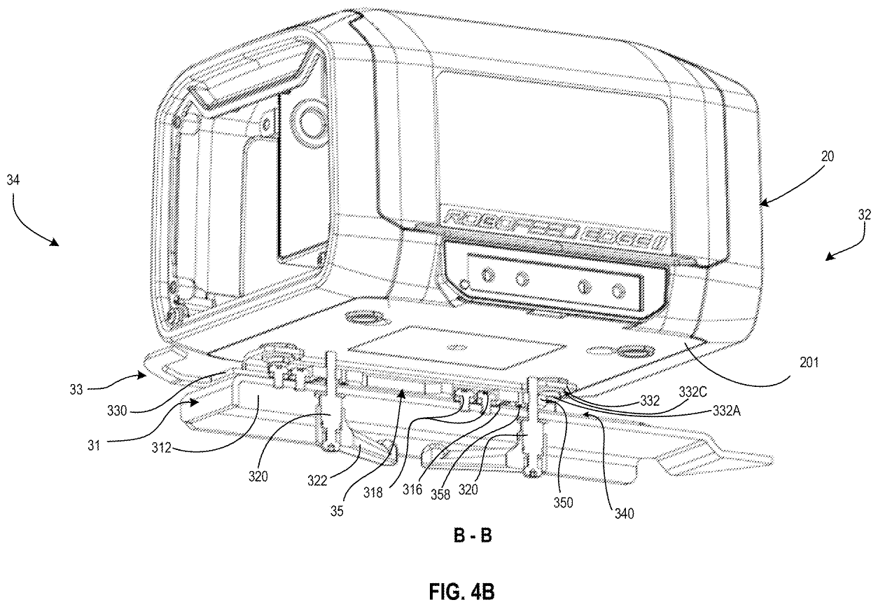

Now referring to FIGS. 4A and 4B, the feeder 20 mounted to the connector assembly 30 is shown. FIG. 4B depicts a cross-section of the connector assembly 30 taken along line B-B of FIG. 4A. With the feeder 20 mounted to the feeder mount 33, the feeder 20 may be configured to move along the longitudinal axis 364 when the feeder plate 330 moves along the longitudinal axis 364. Thus, the feeder 20 can be disposed at a desired position with respect to the adapter plate 312 and the robot arm 102.

As best seen in FIG. 4B, and as previously explained, the feeder mount 33 is coupled to the feeder 20 via the mounting bolts 332A. For example, the mounting bolts 332A extend through the mounting holes 332C in the mounting flange 332 and engage threaded openings in a housing 201 of the feeder 20. A user can access the mounting bolts 332A or insert the mounting bolts 332A through the feeder mount 33 via the access holes 332B (see FIG. 2B).

Still referring to FIG. 4B, the feeder mount 33, and thus the feeder 20, is secured to the robot mount adapter 31 via the clamp 35. In the depicted embodiment, clamping bolts 320 extend through the adapter plate 312 and the slot 340 in the feeder plate 330 to the clamping plate 350. As previously explained, a user can tighten the clamping bolts 320 by hand via the handles 322 to translate the clamping plate 350 towards the adapter plate 312 and clamp the feeder plate 330 in place between the adapter plate 312 and clamping plate 350. That is, the amount of force/pressure applied by the clamping plate 350 to the feeder plate 330 is adjusted by the clamping bolts 320. Further, a user can release the feeder mount 33, and thus the feeder 20, by loosening the handles 322. Once the clamping bolts 320 are loosened, the lift springs 316 lift the clamping plate 350 away from the feeder plate 330 and the adapter plate 312. When the feeder mount 33 is removed, the lift springs 316 maintain a clearance between the clamping plate 350 and adapter plate 312. The clearance allows a user to slide the feeder plate 330 between the clamping plate 350 and the adapter plate 312 to position the feeder 20 on the robotic welder 10.

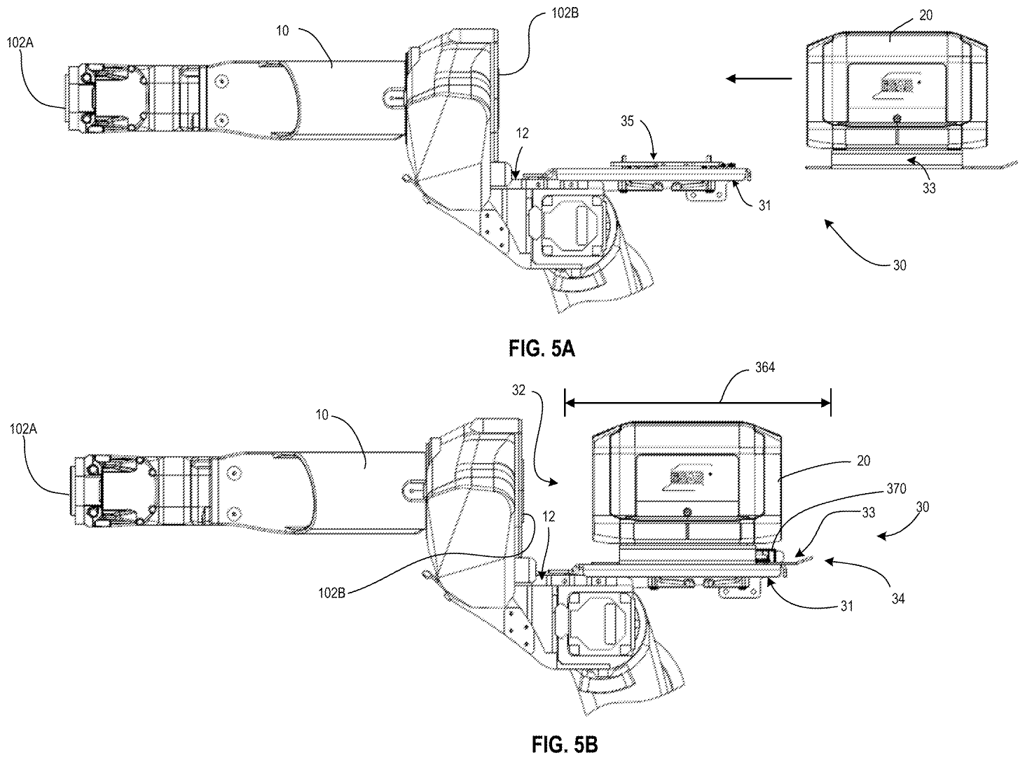

Referring to FIGS. 5A and 5B, and continued reference to FIG. 4B, installation of the feeder 20 to the robotic welder 10 via the connector assembly 30 is illustrated. As depicted in FIG. 5A, the clearance between the clamp 35 and the robot mount adapter 31 allows the feeder mount 33 to slide therebetween and mount the feeder 20 to the robotic welder 10. Additionally, the clearance allows a user to adjust a position of the feeder 20 along the longitudinal axis 364 of the robot mount adapter 31 before clamping. For example, the user can adjust the feeder 20 together with the feeder mount 33 to any desired position, so long as the clamp 35 is at least partially disposed within the clamping area 362 of the feeder plate 330. The desired position may account for various connections between the feeder 20 and the robot arm 102 of the robotic welder 10. The user may then clamp the feeder mount 33 to the robot mount adapter 31 to thereby fix the feeder 20 to the robotic welder 10 in a desired position.

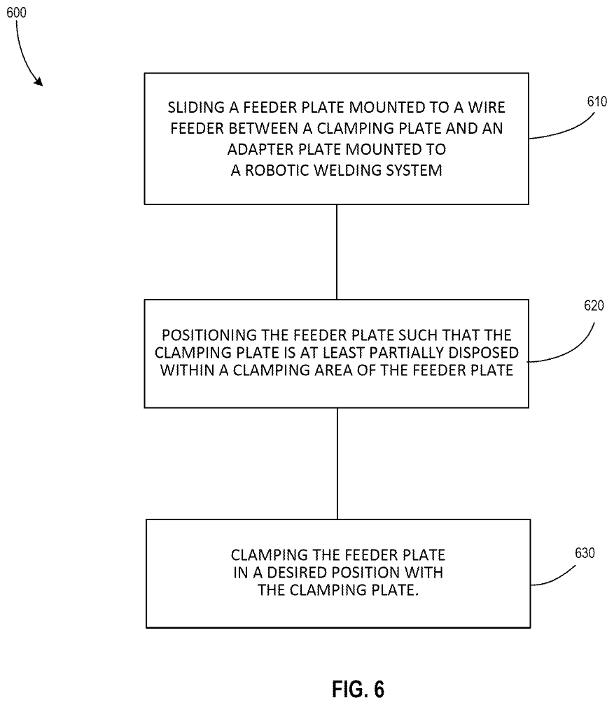

Now referring to FIG. 6, a flow chart for a method 600 for mounting a wire feeder to a robotic welder includes sliding the feeder plate 330 mounted to the wire feeder 20 between the clamping plate 350 and the adapter plate 312 mounted to the robotic welder 10 in operation 610; positioning the feeder plate 330 such that the clamping plate 350 is at least partially disposed within a clamping area 362 of the feeder plate 330 in operation 620; and clamping the feeder plate 330 in a desired position with the clamping plate 350 in operation 630. Clamping the feeder plate 330 with the clamping plate 350 may include tightening clamping bolts 320 extending from the adapter plate 312 to the clamping plate 350. Positioning the feeder plate 330 may comprise sliding the feeder plate 330 to any position within the clamping area 362. Lastly, the method 600 may further include preventing the feeder plate 330 from sliding off the adapter plate 312 via the locking mechanism 370 and/or the slot 334 and spring screws 318.

The spring screws 318 and the slot back end 334B may cooperate to prevent the feeder mount 33 and the connected feeder 20 from sliding off the front end 312A of the adapter plate 312 of the robot mount adapter 31. Meanwhile, the locking mechanism 370 prevents the feeder mount 33 and the attached feeder 20 from sliding off the back end 312B of the adapter plate 312 of the robot mount adapter 31.

Referring to FIGS. 7A-7G, the locking mechanism 370, according to an embodiment, is depicted. FIGS. 7A and 7B show exploded views of the locking mechanism next to the connector assembly 30. FIGS. 7C and 7D are side views of the locking mechanism 370. FIG. 7E is a cross-sectional view of the locking mechanism 370 taken along lines E-E of FIGS. 7C and 7D. FIG. 7F is a partial top view of the connector assembly 30 with the locking mechanism 370 engaging a protrusion 338. FIG. 7G is a partial perspective view of the connector assembly 30 with a partial cross-section of the lock housing 372 taken along lines E-E of FIGS. 7C and 7D. As noted above, the locking mechanism 370 may be mounted to the adapter plate 312 and configured to catch or engage the protrusion 338 (e.g., a locking bolt) extending laterally from the mounting flange 332 to prevent the feeder mount 33 from sliding off the robot mount adapter 31 (as depicted in FIGS. 3C and 3D).

The locking mechanism 370 may comprise a lock housing 372 and a catch plate 374 having a locking slot 376. The catch plate 374 may be mounted to an inner surface 372A of the housing 372 via a screw, or bolt, 377. The housing 372 may be mounted to the adapter plate 312 via bolts, or screws, 378. That is, the bolts 378 may extend through holes 323 in the adapter plate 312 to engage the lock housing 372. The catch plate 374 may be configured to engage/contact a lateral surface of the mounting flange 332 when the feeder mount 33 is disposed between the clamp 35 and the robot mount adapter 31 (see FIGS. 7F and 7G).

The catch plate 374 includes a front portion 374A, a middle portion 374B, a bearing portion 374C and a rear portion 374D. The front portion 374A is substantially flat and includes the indicator 371 for indicating a position of the feeder mount 33. The front portion 374A includes a through-hole for receiving the screw 377 that fixes the catch plate 374 to the housing 372.

The middle portion 374B defines at least a portion of the locking slot 376 for receiving the protrusion 338 extending from the feeder mount 33. The middle portion 374B extends from the front portion 374A at an angle to the bearing portion 374C. That is, the catch plate 374 is bent away from the inner surface 372A of the housing 372 such that the middle portion 374B extends from the front portion 374A at an angle until it reaches the bearing portion 374C.

As depicted in FIGS. 7D-7G, the bearing portion 374C is disposed against/engaged with/in contact with the mounting flange 332 and is configured to stop, or catch, the protrusion 338 of the mounting flange 332 when the feeder mount 33 is disposed in its rearmost position (e.g., the position shown in FIGS. 3C and 3D). The bearing portion 374C extends from the middle portion 374B to the rear portion 374D in a substantially parallel direction to the front portion 374A (see FIG. 7E), and defines an end portion of the slot 376. The bearing portion 374C prevents the feeder plate 330 from sliding off the adapter plate 312 by engaging the protrusion 338 (e.g., a locking bolt). For example, as depicted in FIGS. 7F and 7G, when the feeder mount 33 translates towards the back end 312B of the adapter plate 312 of the robot mount adapter 31, the protrusion 338 slides into the locking slot 376 and engages the bearing portion 374C at the end of the locking slot 376. Thus, the protrusion 338 and the locking slot 376 cooperate to prevent the feeder mount 33 from sliding off the back end 312B of the adapter plate 312 of the robot mount adapter 31. To release the feeder mount 33 for removal of the wire feeder 20, a user may deflect the catch plate 374 by actuating the rear portion 374D.

Still referring to FIGS. 7A-7G, the rear portion 374D may be configured to actuate the catch plate 374 in response to a release force being applied thereto. The rear portion 374D may include a guide surface 382A and a trigger surface 382B. The guide surface 382A of the rear portion 374D may have a first segment that extends at an angle from the bearing portion 374C such that the first segment extends both towards the inner surface 372A of the housing 372 and rearward from the bearing portion 374C. A second segment of the guide surface 382A of the rear portion 374D may extends substantially perpendicularly with respect to the inner surface 372A. The trigger surface 382B of the rear portion 374D may then extends substantially rearward from the second segment of the guide surface 382A of the rear portion 374D.

A user may press on the rear portion 374D to resiliently bias the catch plate 374 away from the mounting flange 332 of the feeder mount 33 and towards the inner surface 372A of the housing 372 to release the feeder mount 33 (e.g., to remove the wire feeder 20 from the robot welder 10). For example, the user may apply a release force to the trigger surface 382B to bias the catch plate 374 away from the feeder mount 33 and to release the protrusion 338 from the locking slot 376. Accordingly, when the clamp 35 is released, the feeder mount 33 and attached wire feeder 20 can be removed from the robot mount adapter 31.

Further, the rear portion 374D also guides the catch plate 374 around the mounting flange 332 of the feeder mount 33 and protrusion 338 during installation/mounting of the feeder mount 33 and wire feeder 20 to the robot mount adapter 31. For example, when the user slides the feeder mount 33 onto the robot mount adapter 31, the mounting flange 332 contacts the angled first segment of the guide surface 382A and biases the catch plate 374 towards the inner surface 372A. As the feeder mount 33 translates forwards (toward the front end 312A of the adapter plate 312), the protrusion engages the angled first segment of the guide surface 382A and further biases the catch plate 374 towards the inner surface 372A. Once the protrusion 338 translates past the rear portion 374D, the catch plate 374 resiliently deflects towards the feeder mount 33 and the bearing portion 374C may be disposed against the mounting flange 332 of the feeder mount 33. In this position, the catch plate 374 will catch the protrusion 338 in the locking slot 376 and prevent the protrusion 338 from translating rearward past the bearing portion 374C. That is, the catch plate 374 blocks the protrusion 338 from translating rearward and prevents the feeder mount 33 and the attached wire feeder 20 from sliding off the robot mount adapter 31. Thus, the catch plate 374 automatically locks the feeder mount 33 once the clamping plate 350 is at least partially disposed within the clamping area 362 of the feeder plate 330 (see FIGS. 3C and 3D). In some implementations, a second locking mechanism 370 may be disposed on the adapter plate 312 on an opposite side of the feeder mount 33.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Reference may be made to the spatial relationships between various components and to the spatial orientation of various aspects of components as depicted in the attached drawings. However, as will be recognized by those skilled in the art after a complete reading of the present disclosure, the devices, components, members, apparatuses, plates, mounts, etc. described herein may be positioned in any desired orientation. Thus, the use of terms such as “above,” “below,” “upper,” “lower,” “top,” “bottom,” “left,” “right,” “front,” “rear,” “side,” “height,” “length,” “width,” “interior,” “exterior,” “inner,” “outer,” or other similar terms merely describe points of reference and do not limit the present invention to any particular orientation or configuration. When used to describe a range of dimensions and/or other characteristics (e.g., time, pressure, temperature, distance, etc.) of an element, operations, conditions, etc. the phrase “between X and Y” represents a range that includes X and Y.

Further, the term “exemplary” is used herein to describe an example or illustration. Any embodiment described herein as exemplary is not to be construed as a preferred or advantageous embodiment, but rather as one example or illustration of a possible embodiment.

Further, the present disclosure may repeat reference numerals and/or letters in the various examples. This repetition is for the purpose of simplicity and clarity, and does not in itself dictate a relationship between the various embodiments and/or configurations discussed.

When used herein, the term “comprises” and its derivations (such as “comprising”, “including,” “containing,” etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the similar terms, such as, but not limited to, “about,” “around,” and “substantially.”

As used herein, unless expressly stated to the contrary, use of the phrase “at least one of,” “one or more of,” “and/or,” and variations thereof are open-ended expressions that are both conjunctive and disjunctive in operation for any and all possible combination of the associated listed items. For example, each of the expressions “at least one of X, Y and Z,” “at least one of X, Y or Z,” “one or more of X, Y and Z,” “one or more of X, Y or Z,” and “X, Y and/or Z” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Further as referred to herein, “at least one of” and “one or more of” can be represented using the “(s)” nomenclature (e.g., one or more element(s)).

Additionally, unless expressly stated to the contrary, the terms “first,” “second,” “third,” etc. are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, “first X” and “second X” are intended to designate two “X” elements that are not necessarily limited by any order, rank, importance, temporal sequence, or hierarchy of the two elements.

1. A connector assembly for a robotic welding system, comprising:
an adapter plate configured to mount to a robotic welder of the robotic welding system;
a feeder plate, the feeder plate configured to couple to a wire feeder of the robotic welding system; and
a clamping plate mounted to the adapter plate and configured to clamp the feeder plate to the adapter plate when at least a portion of the feeder plate is disposed between the clamping plate and the adapter plate.

2. The assembly of claim 1, wherein the feeder plate defines a clamping zone wherein the feeder plate can be positioned and clamped in place with the clamping plate in any location within the clamping zone.

3. The assembly of claim 2, wherein the feeder plate comprises a plurality of mounting flanges for mounting the feeder plate to the wire feeder.

4. The assembly of claim 3, wherein the clamping zone comprises an area bounded by the plurality of mounting flanges, a front end of the feeder plate, and a back end of the feeder plate.

5. The assembly of claim 2, wherein the feeder plate comprises a slot longitudinally from a front end and through the clamping zone.

6. The assembly of claim 5, further comprising a clamping bolt extending through the adapter plate, the slot, and the clamping plate, wherein the clamping bolt is configured to pull the clamping plate towards the adapter plate.

7. The assembly of claim 1, further comprising a locking mechanism configured to prevent the feeder plate from sliding off the adapter plate.

8. The assembly of claim 7, wherein the locking mechanism comprises a lock housing mounted to the adapter plate and a catch plate disposed in the lock housing, the catch plate being biased towards the feeder plate.

9. The assembly of claim 8, wherein the locking mechanism further comprises a protrusion extending from a mounting flange of the feeder plate, and the catch plate further comprises a slot configured to receive the protrusion.

10. A connector assembly for a welding system, comprising:
a first plate configured to be mounted to a first device of the welding system;
a clamping plate operatively coupled to the first plate for applying a clamping force toward the first plate; and
a second plate configured to be mounted to a second device of the welding system, the second plate being configured to slide between the first plate and the clamping plate, wherein the second plate is secured to the first plate when at least a portion of the second plate is disposed between the first plate and the clamping plate and the clamping plate applies the clamping force on the second plate.

11. The connector assembly of claim 10, wherein the second plate defines a clamping zone configured to receive the clamping force, wherein the clamping zone is larger than the clamping plate.

12. The connector assembly of claim 10, further comprising a locking mechanism configured to prevent the second plate from sliding off the first plate.

13. The connector assembly of claim 12, wherein the locking mechanism comprises a lock housing mounted to the first plate and a catch plate disposed in the lock housing, the catch plate being biased towards the second plate.

14. The connector assembly of claim 13, wherein:
the second plate further comprises a mounting flange extending perpendicularly from the second plate, and a protrusion extending perpendicularly from the mounting flange; and
the catch plate further comprises a slot configured to receive the protrusion.

15. The connector assembly of claim 10, wherein the first device is a robotic welder, and the second device is a wire feeder.

16. A method for mounting a wire feeder to a robotic welding system, the method comprising:
sliding a feeder plate mounted to the wire feeder between a clamping plate and an adapter plate mounted to the robotic welding system;
positioning the feeder plate such that the clamping plate is at least partially disposed within a clamping area of the feeder plate; and
clamping the feeder plate in a desired position with the clamping plate.

17. The method of claim 16, wherein clamping the feeder plate with the clamping plate comprises tightening clamping bolts extending from the adapter plate to the clamping plate.

18. The method of claim 16, wherein positioning the feeder plate comprises sliding the feeder plate to any position where the clamping plate is at least partially disposed within the clamping area.

19. The method of claim 16, further comprising preventing the feeder plate from sliding off of the adapter plate via a locking mechanism mounted to the adapter plate, the locking mechanism comprising a catch plate.

20. The method of claim 19, wherein the feeder plate comprises a protrusion extending from the feeder plate, and wherein preventing the feeder plate from sliding off of the adapter plate comprises engaging the protrusion with a slot disposed in the catch plate.
